(19) United States
(12) Patent Application Publication
(10) Pub. No.: US 2024/0013268 A1
(43) Pub. Date: Jan. 11, 2024

(54) SYSTEMS AND METHOD FOR UTILITY CONSUMPTION OF DATA

(71) Applicant: OMNY, Inc., Atlanta, GA (US)

(72) Inventors: Sean O'Brien, Atlanta, GA (US); Maik Lindner, Roswell, GA (US); Stella Chang, Vienna, VA (US)

(73) Assignee: OMNY, Inc., Atlanta, GA (US)

(21) Appl. No.: 18/218,969

(22) Filed: Jul. 6, 2023

Related U.S. Application Data
(60) Provisional application No. 63/359,122, filed on Jul. 7, 2022.

(51) Int. Cl. G06Q 30/04; G06Q 20/40

(52) U.S. Cl. CPC G06Q 30/04; G06Q 20/407

(57) ABSTRACT

Systems and method for utility consumption of data are enclosed. The system may include at least one memory and at least one processor. The at least one memory may store a plurality of data sets and one or more non-transitory computer-executable instructions. The at least one processor, in response to executing the one or more instructions, may implement a method or execute a micro data engine configured to implement a method. The method may include receiving a data request with data requirements from a client. The method may include arranging a product data set including a selection of the plurality of data sets based on the data requirements. The method may include calculating the number of micro data units in the product data set. The method may include transmitting the product data set to the client. The method may include transmitting an invoice to the client.

### CROSS-REFERENCES TO RELATED APPLICATIONS

This application claims priority to U.S. Provisional Patent Application No. 63/359,122, entitled “A System and Method for Utility Consumption of Data based on micro (μ) Data Units and a micro (μ) Data Engine (uDU),” which was filed Jul. 7, 2022. The entirety of this reference is hereby incorporated by reference.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present disclosure relates generally to data engines and more particularly data engines that allow for utility consumption of data.

Researchers in some industries need real-world data to conduct research. For example, medical research often relies on real-world data to avoid the need for expensive and time-consuming clinical trials or surveys. Real-world data includes any data that is generated about subjects that is not collected primarily to support research initiatives. For example, electronic health records or health insurance claims repurposed for research are examples of real-world data. Clinical trial data or surveys (e.g., NHANES) are not real-world data.

Real-world data may be used in medical research for various purposes including to understand current and emerging diseases to develop new treatments, to evaluate the effectiveness or side effects of a treatment beyond the controlled environment of a clinical trial, or to track patient populations over time to understand the long-term outcomes of diseases and their treatments. To operate efficiently, research organizations need to find and invest in real-world data that most closely supports their research objectives. The nature of the data required by researchers is often based on disease or therapeutic areas, geographies, demographics, or time frames of the data (patient history and recency of records).

Studies must be designed with the source and content of the real-world data in mind. Often medical researchers must procure large volumes of data that require filtering to the data points associated with a cohort of patients relevant to a study. A typical filter consists of patients with a certain disease within specific demographic strata (e.g., age 18 and older, males) who were or were not treated with a certain drug within a specified period. Even if the study includes an untreated control group, the researcher typically ends up with large amounts of data that remain unused.

Further complicating the task of obtaining data, the direction, focus, or underlying research question is often modified or changed in the short- or midterm. For example, the emergence of the COVID-19 pandemic required life sciences companies and federal research agencies to shift their research priorities from treatment of chronic diseases to vaccines and antiviral treatments. As a result, researchers' data needs change. This often means that researchers must go through a procurement process for a new or adjusted data set with no option to swap data, resulting in a lengthy endeavor and wasted resources.

In most circumstances, researchers, and the institutions they work for, need to pay for data sets. The cost of a data set is mainly determined by content, volume, and recency of events captured. Providers of real-world data are mostly private entities who license data as long-term subscriptions (with refreshes) or in perpetuity (one-time procurement with no refreshes). Even government agencies that offer real-world data (e.g., Centers for Medicare and Medicaid Services, Agency for Health Research and Quality) offer data under the same construct. A research institution might also already have a base data set, a corporate data set, which is available to internal and collaborative external researchers. However, researchers must still determine the coverage of the existing base data set compared to the requirements of the use case.

Currently data sets are priced by various factors. These factors differ from data provider to data provider and generally follow the dynamics of a supply and demand model. Most data offerors provide resources to explore and build a cohort of individuals and their data for a study so that the data buyer procures a data set with records of just that cohort of individuals. Regardless of the cohort or data set, the model remains the same—a one-time decision for a particular cohort of patients and use of data for just that cohort during the period of license.

This model assumes that research institutions understand all current and future data needs at the time of budgeting and spending, or that they reserve additional budget for new data acquisition. This model does not accommodate events that change can quickly and drastically change research priorities, such as the emergence of a new disease, natural disasters, regulatory decisions (e.g., a treatment does not receive FDA approval, Medicare chooses not to cover a device), or corporate decisions (a large pharmaceutical company acquires a new molecule). Research institutions are forced to buy data sets that are relevant for a particular set of studies but have no opportunity to flexibly adjust that data set to new and upcoming needs of the study or use case. Adjusting the data set available to a research institution could mean the purchase of completely new data sets with the associated cost. The current alternative is to invest in enterprise licenses of entire data sets, but these data sets rarely have the deep clinical data and specific patient information that specialized data sets offer. A few data marketplaces offer another alternative, which is a subscription to access any data set on the marketplace for a fixed period. However, only large multinational research organizations have budgets for this offering and the marketplace may not have all the required data sources. Smaller research organizations, academic and non-profit researchers, and government agencies cannot afford these options. No current option supports a mechanism to return unused data or flexibly adjust the data requirements depending on study or use case findings.

What is needed then are improvements to data engines that allow for utility consumption of data and overcome many of the shortcomings described herein.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The systems and methods of the present disclosure help in overcoming the problems identified in the Background section, in addition to other problems. The systems and methods described herein provide data according to the data coverage needs of individual use cases and increases the efficiency of the system by only providing subsections of data sets that are needed for a particular study. The systems and methods of the present disclosure may be used to detect overlaps in the data (either in terms of the actual data itself or in the populations sampled by the data), thereby avoiding the transmission of unnecessary data and creating economic synergies between two otherwise separate studies and data sets. Furthermore, the systems and method of the present disclosure also provide transparency into the cohort underlying multiple data sets such that a client only pays for utilized data once. The systems and methods of the present invention provide data transparency and rules, procedures, and processes for determining fair prices for transactions within the data market.

One aspect of the disclosure is a system. The system may include at least one processor and at least one memory storing one or more non-transitory computer-executable instructions and a plurality of data sets. The at least one processor may, in response to executing the one or more instructions, implement a method or execute a micro data engine configured to implement a method. The method may include one or more operations or steps. In some embodiments, the method may include receiving a data request including data requirements from a client; arranging a product data set including a selection of the plurality of data sets based on the data requirements; calculating the number of micro data units in the product data set; transmitting the product data set to the client; and transmitting an invoice to the client based on the number of micro data units in the product data set.

In some embodiments, the method implemented by the at least one processor may include receiving a data request from a client; transmitting data to the client based on the data request; calculating in micro data units the consumption of data by the client; calculating a price per micro data unit consumed by the client; and transmitting an invoice to the client based on the number of micro data units consumed by the client and the price per micro data unit. In other embodiments, the method implemented by the at least one processor may include receiving a first data request from a client; transmitting a first product data set to the client based on the first data request; receiving a second data request from the client; transmitting a second product data set to the client based on the second data request; detecting overlapping data between the first product data set and the second product data set; calculating the number of discrete micro data units in the first and second product data, wherein the number of discrete micro data units excludes any duplicate micro data units in the first and second product data sets; and transmitting an invoice to the client based on the number of discrete micro data units.

The invention of the present disclosure provides several improvements to the functioning of computers. For example, the systems and methods also arrange data based on the use case and only provide subsections of data sets that are needed for the use case, which in turn increases the efficiency of the system. Moreover, the systems and methods herein are capable of analyzing vast quantities of data and arranging data into data sets in a multitude of different combinations based on the use case, far beyond the capabilities of prior art data distribution processes that were performed mentally or by hand. The systems and methods also identify overlaps in the data and detects synergies between data sets needed for separate studies to prevent the unnecessary transmission of data and unnecessary storage of data by the client, which in turn lower costs for clients and increases data access speeds and processing speeds of the system.

Numerous other objects, advantages, and features of the present disclosure will be readily apparent to those of skill in the art upon a review of the following drawings and description of a preferred embodiment.

### BRIEF DESCRIPTION OF THE DRAWINGS

FIG. 1 is a schematic block diagram illustrating one embodiment of a system for utility consumption of data

FIG. 2 is a schematic block diagram illustrating exemplary data that may be stored in the system shown in FIG. 1.

FIG. 3 depicts an exemplary embodiment of a data set for use with the system of FIG. 1.

FIG. 4 is a schematic block diagram illustrating an exemplary set of micro data factors for use with the system of FIG. 1.

FIG. 5A is an illustration of a plurality of data sets that may be stored in the at least one memory of the system of FIG. 1.

FIG. 5B is another illustration of a plurality of data sets that may be stored in the at least one memory of the system of FIG. 1.

FIG. 5C is yet another illustration of a plurality of data sets that may be stored in the at least one memory of the system of FIG. 1.

FIG. 6 is schematic block diagram illustrating quality data and its subcategories that may be used with the system of FIG. 1.

FIG. 7 is a flowchart diagram illustrating one embodiment of a method for utility data consumption.

FIG. 8 is a flowchart diagram illustrating another embodiment of a method for utility data consumption.

FIG. 9 is a flowchart diagram illustrating yet another embodiment of a method for utility data consumption.

### DETAILED DESCRIPTION

While the making and using of various embodiments of the present invention are discussed in detail below, it should be appreciated that the present invention provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

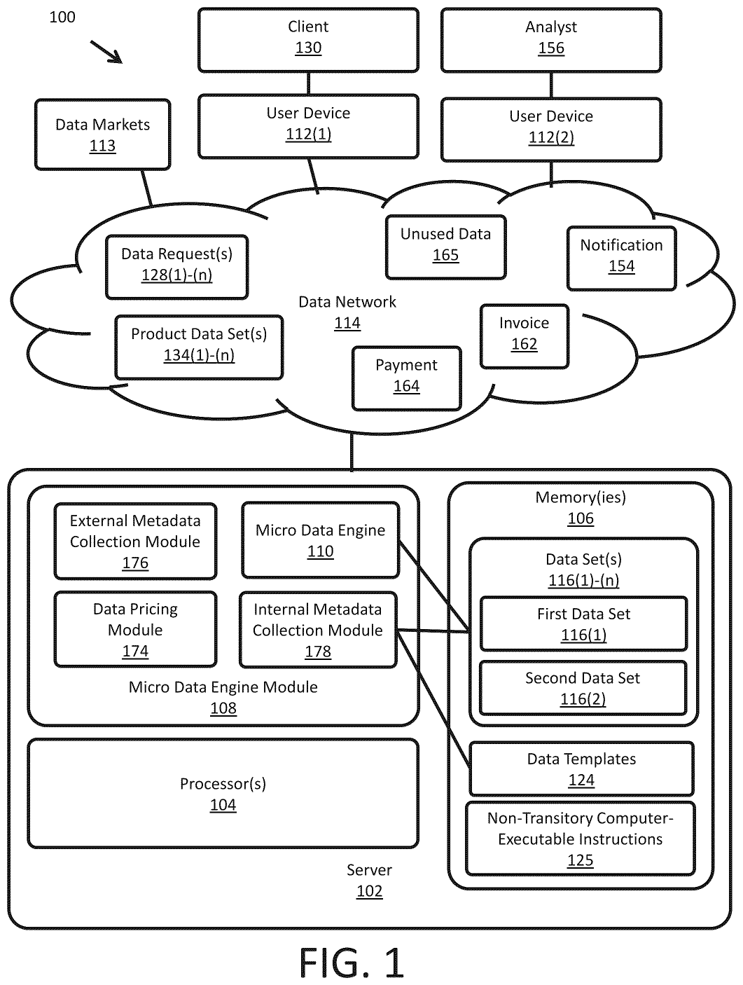

The following is a brief overview of one embodiment of a system 100 of the present disclosure. FIG. 1 depicts one embodiment of the system 100. The system 100 may include a server 102. The server 102 may also include at least one processor 104 and at least one memory 106. In some embodiments, the server 102 may include a micro data engine module 108. In such embodiments, the system 100 may be a micro data engine 110 for utility consumption of data.

In some embodiments, the system 100 may include one or more user devices 112(1)-(n). Although two user devices 112(1)-(2) are depicted in FIG. 1, the system 100 may include any number of user devices 112(1)-(n). As discussed herein, a single user device, in general, is referred to as a “user device 112,” a particular user device is referred to as “user device 112(1),” “user device 112(2),” etc., and all of the one or more user devices are referred to as “the one or more user devices 112(1)-(n).” The one or more user devices 112(1)-(n) may include graphic user interfaces and other input devices and output devices.

In one or more embodiments, the system 100 may include a data network 114. The server 102 and the one or more user devices 112(1)-(n) may be in data communication with each other via the data network 114. The server 102 and the one or more user devices 112(1)-(n) may send data over the data network 114 and may receive data over the data network 114. The server 102 or micro data engine module 108 may be able to access data markets 113 over the data network 114.

The server 102 may include a computing device such as an application server. The micro data engine module 108 may include software installed and executable on the server 102 that implements or generates a micro data engine 110, interacts with the micro data engine 110, stores the micro data engine 110, or otherwise processes data associated with the micro data engine 110.

In some embodiments, the at least one memory 106 may store data organized into a plurality of data sets 116(1)-(n). As discussed herein, a single data set, in general, is referred to as a “data set 116,” a particular user device is referred to as “data set 116(1),” “data set 116(2),” etc., and all of the one or more user devices are referred to as “the plurality of data sets 116(1)-(n).” The plurality of data sets 116(1)-(n) may be organized into a plurality of records 118 that include one or more data entries 120 in one or more data fields 122. The at least one memory 106 may also store a plurality of data templates 124 corresponding to the plurality of data fields 122.

The at least one memory 104 may store non-transitory computer-executable instructions 125 that, when executed by the at least one processor 104, cause the system 100, and in particular, the micro data engine module 108 to facilitate the transfer of data to third parties such as research organizations. The transfer of data may include the transfer of data as measured in micro data units 126. As used herein, a “micro data unit” is a quantifiable measure of the value of any given data set within a specific industry or domain that can be used to communicate and compare the value of data sets across enterprise boundaries and specifically across data provider boundaries. The calculation of the number of micro data units 126 with a data set 116 is discussed in more detail elsewhere herein.

The micro data engine module 108 may receive a data request 128 from a client 130. The data request may include data requirements. The data requirements 132 may include at least one of volume requirements 132(1), geographic requirements 132(2), demographic requirements 132(3), or condition requirements 132(4). In some cases, multiple data requests 128(1)-(n) may be received from the client 130. As discussed herein, a single data request, in general, is referred to as a “data request 128,” a particular data request is referred to as “data request 128(1),” “data request 128(2),” etc., and all of the one or more user devices are referred to as multiple “data requests 128(1)-(n).” For example, a first data request 128(1) and a second data request 128(2) may be received from the client 130.

The micro data engine module 108 may arrange a product data set 134 including a selection of data from the plurality of data sets 116(1)-(n). The product data set 134 may be arranged from the plurality of data sets 116(1)-(n) based on the data requirements 132. For example, the arranging of the product data set 134 may include analyzing the data requirements 132 for data need coverage. The analyzing the data requirements 132 for data need coverage may include performing data point counts and analyzing at least one of the volume requirements 132(1), geographic requirements 132(2), demographic requirements 132(3), or condition requirements 132(4).

The micro data engine module 108 may be configured to calculate the number of micro data units 126 in the product data set 134. In some embodiments, the calculating the number of the micro data units 126 in a data set 116 is performed using one or more micro data factors 136. Examples of micro data factors include cohort size factors 136(1) measured in number of subjects, geographic factors 136(2) measured in the number of regions, or condition factors 136(3) measured in number of discrete variables for research contained in the data. In some embodiments, the one or more micro data factors 136 correspond to the one or more data fields 122 and/or one or more data entries 120 in each of the one or more data fields 122 in the plurality of records 118.

In some embodiments, the micro data engine module 108 may be configured to calculate the number of micro data units 126 in the product data set 134 by dividing the number of discrete data entries 120 in the one or more data fields 122 by the corresponding one or more micro data factors 136 to produce one or more factor coverage values 138; assigning the maximum factor coverage value 138 of the one or more factor coverage values 138 for the each of the plurality of data sets 116(1)-(n) as the number of micro data units 126 in each of the plurality of data sets 116(1)-(n); and determining the number of micro data units 126 in the selection of the plurality of data sets 116(1)-(n) sets forming the product data set 134. In other embodiments, the calculating the number of micro data units 126 in the product data set 134 comprises calculating the number of records 118 in each micro data unit for each of the plurality of data sets 116(1)-(n) and dividing the number of records 118 in the product data set 134 from each of the plurality of data sets 116(1)-(n) by the number of records 118 in each micro data unit 126 for each of the plurality of data sets 116(1)-(n).

The micro data engine module 108 may be configured to transmit data to the client 130. For example, the micro data engine module 108 may transmit the product data set 134 to the client 130. As discussed herein, a product data set, in general, is referred to as a “product data set 134,” a product data set is referred to as “product data set 134(1),” “product data set 134(2),” etc., and all of the one or more user devices are referred to as multiple “product data sets 134(1)-(n).” If multiple product data sets 134(1)-(n) are requested by the client, the micro data engine module 108 may be configured to transmit multiple product data sets 134(1)-(n) to the client 130. For example, the micro data engine module 108 may be configured to transmit the first and second product data sets 134(1)-(2) to the client 130. In some embodiments, the micro data engine module 108 may be configured to calculate the consumption of data by the client 130. The calculating of the consumption of data by the client 130 may be performed over a time interval, which may be based on the data requirements 132.

The micro data engine module 108 may be configured to calculate a price per micro data unit 140 for the micro data units consumed by the client 130. The calculating of the price per micro data unit 140 may include analyzing external metadata 142. In some embodiments, the micro data engine module 108 may be configured to collect external metadata 142. Collection of external metadata 142 may be performed automatically and/or constantly.

The calculating of the price per micro data unit 140 may include analyzing internal metadata 144. Internal metadata may include at least one of volume data 146 and quality data 148 about the plurality of data sets 116(1)-(n). The quality data 148 may include at least one of the scope data 148(1), completeness data 148(2), accuracy data 148(3), or relation data 148(4). In some embodiments, analyzing of the internal metadata 144 may include collecting internal metadata 144 by comparing the plurality of data templates 124 to the corresponding plurality of data fields 122 in the records of the plurality of data sets 116.

The micro data engine module 108 support or enforce rules for calculating of the price per micro data unit 140. For example, the micro data engine module 108 may determine that the calculated price per micro data unit 140 is below a predetermined lower price 150 or that the calculated price per micro data unit is above a predetermined upper price 152. The micro data engine module 108 may transmit a notification 154 to an analyst 156 to review the calculated price per micro data unit 140 if the micro data engine module 108 determines that the calculated price per micro data unit 140 is below the predetermined lower price 150 or above the predetermined upper price 152. As another example, the micro data engine module 108 may have a predetermined maximum price 158 and a predetermined minimum price 160, and the micro data engine module 108 may ensure that the calculated price per micro data unit 140 is between the predetermined maximum price 158 and the predetermined minimum price 160.

When multiple data sets 116(1)-(n) are transmitted to a client 130, the micro data engine module 108 may be configured to detect overlap in the data contained in the multiple data sets 116(1)-(n). For example, when the first and second product data sets 116(1)-(2) are transmitted to the client, the micro data engine module 108 may detect overlapping data between the first product data set 116(1) and the second product data set 116(2). The micro data engine module 108 may calculate the number of discrete micro data units 126 in the first and second product data sets 116(1)-(2). The number of discrete micro data units 126 excludes duplicate micro data units 126 in the first and second product data sets 116(1)-(2).

The micro data engine module 108 may be configured to transmit an invoice 162 to the client 130 based on the price per micro data unit 140, the number of micro data units 126 in the product data set 134, the number of micro data units 126 provided to the client 130 in multiple product data sets 134(1)-(n), and/or the consumption of data by the client 130. The micro data engine module 108 may be configured to receive a payment 164 from the client in response to the invoice 162. In some embodiments, the micro data engine module 108 may receive from the client unused data 165 from the product data set(s) 134(1)-(n) and may issue a refund of the payment 164 based on the amount of unused data 165 from the product data set(s) 134(1)-(n).

The following explains details of some embodiments of the system 100 of the present disclosure. In one embodiment, the server 102 may include an application server, a database server, another type of server, a desktop computer, laptop computer, tablet computer, mobile computing device, or some other type of electronic device. The server 102 may include at least one memory 106.

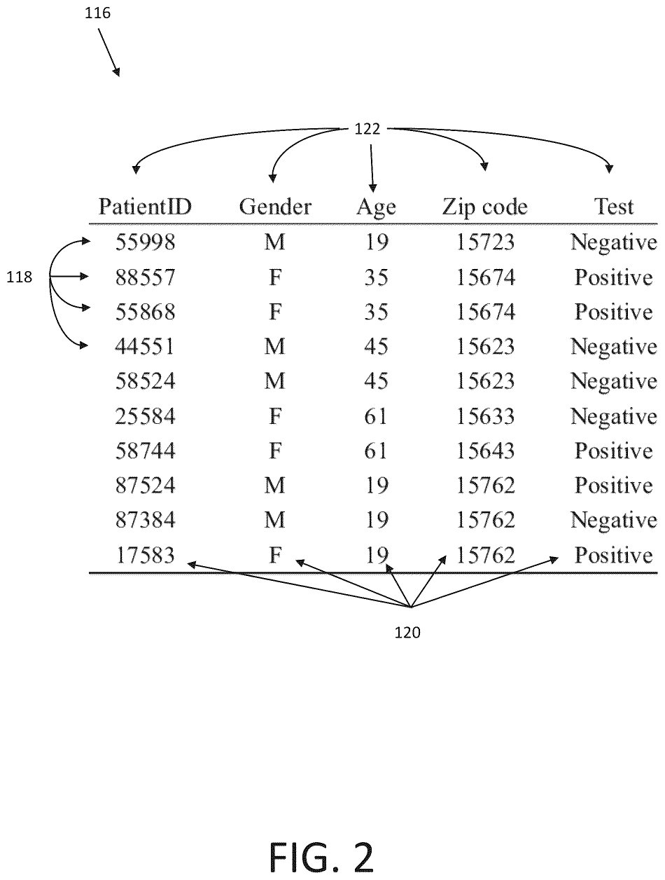

The at least one memory 106 may be a non-transitory storage device, such as a hard disk, flash memory, random access memory (RAM), or other types of non-transitory storage devices. The at least one memory 106 may store data such as the micro data engine module 108 or non-transitory computer-executable instructions 125. FIG. 2 illustrates an embodiment of the at least one memory 106 and the various data that can be stored in the at least one memory 106. As shown in FIG. 2, the at least one memory 106 may include a data warehouse 125 storing a plurality of data sets 116(1)-(n). The plurality of data sets 116(1)-(n) may include numerical data sets, categorical data sets, time series data sets, spatial data sets, textual data sets, image data sets, audio data sets, graph data sets, biological data sets, sensor data sets, or combinations thereof. The plurality of data sets 116(1)-(n) may include data for use in medical research, environmental research, biological research, social sciences research, physical sciences research, engineering research, agricultural research, energy research, space research, behavioral research, computer science and/or information technology research, education research, cultural research, geological research, mathematical research, other types of research, and combinations thereof. The at least one memory 106 may store one or more other types of software, modules, values, metadata, files, or other data discussed herein.

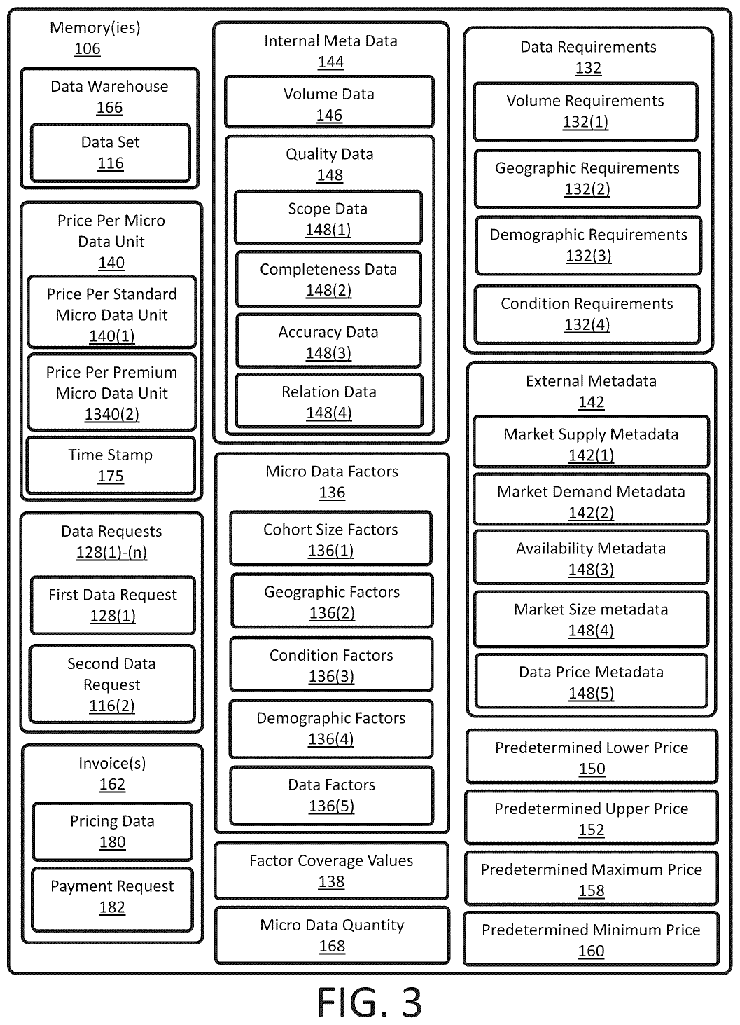

FIG. 3 depicts one embodiment of a data set 116 from the plurality of data sets 116(1)-(n) for use with the present invention. In FIG. 3, the data set 116 is a medical data set containing textual and numeric data on a group of persons. The data in the data set 116 may be organized into a plurality of records 118. Each record 118 may relate to a particular subject. For example, in FIG. 3, each row represents one of the plurality of records 118 includes medical data corresponding to a single person. As used herein, “subject” may refer to persons, animals, buildings, vehicles, or other classes of things depending on the type or field of use of the data set 116. Each record 118 may include one or more data entries 120 corresponding to one or more of the data fields 122. In FIG. 3, the one or more data entries 120 are represented by the cells in each row and column.

Each record 118 may include one or more data fields 122. In FIG. 3, the columns represent the one or more data fields 122. Examples of data fields 122 include the following: subject identification data field including textual identifiers, such as a name (when the subject is a person) or an address (when the subject is a structure), and/or a numeric identifiers, such as an ID number; geographic data fields such as the location of the subject; time or duration data fields such as the time or duration over which specific events occurred or measurements were taken; demographic data fields including demographic data (e.g., for persons: age, gender, ethnicity, nationality education, income, occupation, employment status, etc.), relevant characteristics, or inclusion/exclusion criteria; measurement or variable data fields for measurements taken or variables collected during a study; experimental condition data fields including experimental conditions used or interventions offered; outcomes or results data fields containing data on the outcomes, results, or measurements obtained from subjects; statistical data fields such as p-values, effect sizes, confidence intervals, or any other statistical measures used to analyze and interpret the data; date or timestamp data fields for capturing the date or time when measurements where taken or variables were collected; or metadata fields including data on contextual information about the records or data in a record, such as data source, data collection methods, or any other relevant information that helps in understanding and interpreting the data.

The server 102 may include at least one processor 104 for executing the non-transitory computer-executable instructions 125 or processing other data. Although the at least one processor is described herein as executing the non-transitory computer-executable instructions 125, it is understood that the actions of the at least one processor 104 may be imputed to the server 102 or the system 100. In some embodiments, the micro data engine module 108 may include software installed on or executed by the at least one processor 104. When executed by the at least one processor 104, the non-transitory computer-executable instructions 125 may cause the at least one processor to initialize a micro data engine 110.

A data engine is a software system that provides the underlying infrastructure and functionality to efficiently process, store, and retrieve data. Data engines are designed to handle specific tasks such as data storage, data processing, or data retrieval. Data engines are optimized to manage different types and volumes of data and enable users to perform various operations and analysis on the data. In this case, the micro data engine module 108 and micro data engine 110 (which elsewhere herein may be referred to interchangeably) are optimized to manage and analyze data in micro data units 126. The micro data engine module 108 may be configured to perform or implement one or more operations described herein. Although such operations may be described as performed by the micro data engine module 108 or micro data engine 110, it is understood that such operations may also be described as performed or implemented by the at least one processor 104, the server 102, or the system 100.

In some embodiments, the one or more user devices 112(1)-(n) may include servers, desktop computers, laptop computers, mobile computing devices, or some other type of computing device. A user device 112 may include client software installed on the user device 112. The client software may include software configured to communicate with the server 102 or other user devices 112(1)-(n). The client software may communicate with the server 102 to receive data from the micro data engine module 108, send data to the micro data engine module 108, conduct transactions or transmit payments between the user device and the micro data engine module 108, or otherwise communicate with or effect change on the server 102.

In one embodiment, the data network 114 may include a local area network (LAN), a wide area network (WAN), a wireless network, a wired network, the Internet, or some other kind of data network. The data network 114 may facilitate the transmission of data between connected components of the data network 114. The data network may include wires, routers, switches, servers, internet service providers (ISPs), or other network components. The one or more components of the system 100 may send data, inquiries, queries, requests, notifications, messages, responses, or other information to each other via the data network 114. These categories of information may not be exclusive and may overlap. Such information may be sent in data packets using networking protocols such as Internet Protocol (IP), Transmission Control Protocol (TCP), or other methods of sending data in a network.

In one embodiment, the micro data engine 110 may receive a data request 128 from a client 130. As used herein, “client” 130 may refer to any third party and may, but does not necessarily, imply a customer relationship between the entity operating the system of the present invention and the third party. Generally, the client 130 is a researcher or research organization needing data to conduct a study or other research. However, it is understood that the systems and methods of the present invention can be used to provide data to any third party requiring data. In some embodiments, the micro data engine 110 may receive multiple data requests 128(1)-(n) from the same client 130 or different clients 130. The client 130 may transmit the data request 128 to the micro data engine 110 through the data network 114 via the user device 112.

Data requests 128 may include data requirements 132. The data requirements 132 may include at least one of volume requirements 132(1), geographic requirements 132(2), demographic requirements 132(3), or condition requirements 132 (4). Volume requirements 132(1) may include requirements for a minimum number of records 118, data about a minimum number of subjects, or a minimum number of data sets 116. For example, the client 130 may need a minimum volume of data to be able to reach a conclusion with a desired level of confidence. Geographic requirements 132(2) may include requirements for data about subjects from particular regions or subjects from a minimum number of different regions. Examples of geographic requirements can include countries, geographic regions (northeast, southeast, midwest, etc.), states, cities, metro areas, zip codes, or other defined regions. Demographic requirements 132(3) may include requirements for data about subjects from a particular demographic or data covering subjects from a minimum number of different demographics. Condition requirements 132(4) may include requirements for data about subjects meeting particular conditions or a minimum number of conditions. In the medical field, conditions may include medical history, medical conditions, medications taken, medical procedures received, etc. For example, a medical researcher may desire to have data covering one thousand male patients in the age range of twenty to thirty years old with at least fifty patients in each of ten different zip codes having symptoms of a heart arrhythmia with a portion of the patients taking magnesium or having had an ablation performed.

The micro data engine 110 may be configured to arrange a product data set 134 including a selection of data from the plurality of the data sets 116(1)-(n). In some embodiments, the product data set 134 may include a portion of the plurality of records 118 from one or more of the plurality of data sets 116(1)-(n). The product data set 14 may be arranged by selecting one or more of the plurality of data sets 116(1)-(n) (or portions of the plurality of records 118 from one or more of the plurality of data sets 116(1)-(n)) that satisfy the data requirements 132. The arranging of the product data set 134 may include analyzing the data requirements 132 for data need coverage, which may further include analyzing at least one of the volume requirements 132(1), the geographic requirements 132(2), the demographic requirements 132(3), or the condition requirements 132(4). The arranging of the product data set 134 may also include performing data point counts to ensure compliance with the volume requirements 132(1) and/or analyzing the plurality of data sets 116(1)-(n) to select one or more of the plurality of data sets 116(1)-(n) (or portions of the plurality of records 118 from one or more of the plurality of data sets 116(1)-(n)) that satisfy the data requirements 132. In some embodiments, the micro data engine 110 may select the minimum number of the plurality of data sets 116(1)-(n) or the minimum number of records 118 from one or more of the plurality of data sets 116(1)-(n) necessary to satisfy the data requirements 132.

In one embodiment, the micro data engine 110 may calculate the number of micro data units 126 in one or more of the plurality of data sets 116(1)-(n) or the product data set(s) 134. As described above, a micro data unit 126 is a quantifiable measure of the value of any given data set within a specific industry or domain that can be used to communicate and compare the value of data sets across enterprise boundaries and specifically across data provider boundaries. The calculating the number of micro data units 126 in a data set 116 is performed using the one or more micro data factors 136. Micro data factors 136 are factors used to assess or measure the number of micro data units 126 in a data set 116. Micro data factors 136 may correspond to the one or more data fields 122 or combinations of data fields 122 contained in the plurality of data sets 116(1)-(n). Examples of micro data units 126 include but are not limited to cohort size factors 136(1), geographic factors 136(2), conditions factors 136(3), demographic factors 136(4), data factors 136(5), or combinations thereof.

Micro data factors 136 of different types may have different predetermined numeric values associated with them. These numeric values may be selected to facilitate a comparison of the value of different data types contained in a data set 116. For example, a relatively high numeric value for a micro data factor 136 may show that data corresponding to that micro data factor 136 has a relatively low research value. In contrast, a relatively low numeric value for a micro data factor 136 may show that data corresponding to that micro data factor 136 has a relatively high research value. The selection or predetermined numeric values of the micro data factors 136 used to quantify the number of micro data units 126 in each data set 116 may vary based on the industry or field to which the data relates or the type of data contained in the data set 116.

Cohort size factors 136(1) may be used to analyze the research value of a data set 116 based on the number of subjects covered by the data set 116. Cohort size factors 136(1) may be measured in units of a predetermined number of subjects. Cohort size factors 136(1) may correspond to subject identification data fields. As an example, a particular cohort size factor 136(1) may be equal to 100× subjects.

Geographic factors 136(2) may be used to analyze the research value of a data set 116 based on the number of geographies covered by the data set 116. Geographic factors 136(2) may be measured in units of a predetermined number of discrete regions and may correspond to geographic data fields. As an example, a particular geographic factor 136(2) may be equal to 10× three-digit zip codes.

Condition factors 136(3) may be used to analyze the research value of a data set 116 based on the number of conditions or variables covered by the data set 116. Condition factors 136(3) may be measured in units of a predetermined number of a particular condition(s) or variable(s) and may correspond to measurement or variable data fields, experimental condition data fields, or outcome or results data fields. As an example, a particular condition factor 136(3) may be equal to 2× diseases, which may be represented by ICD-10 codes).

Demographic factors 136(4) may be used to analyze the research value of a data set 116 based on the number of demographics covered by the data set 116. Demographic factors 136(4) may be measured in units of a predetermined number of discrete demographics and may correspond to demographic data fields. As an example, a particular demographic factor 136(4) may be equal to 2× age groups.

Data factors 136(5) may be used to analyze the research value of a data set 116 based on the characteristics of the data covered by the data set 116. Data factors 136(5) may be measured in units of a predetermined number of the characteristic (number of different data types, number of data sources, method of data collection, dates or time periods that the data was collected within, etc.) of the data set 116. Data factors 136(5) may correspond to statistical data fields, date or timestamp data fields, data timeliness, data source, or metadata fields. As an example, a particular data factor 136(5) may be equal to 3× data types.

In some embodiments, a micro data factor 136 may be a combination of cohort size factors 136(1), geographic factors 136( ), condition factors 136(3), demographic factors 136(4), or data factors 136(5). For example, one micro data factor 136 may be equal to one hundred subjects having greater than ten measurements of a particular variable. As another example, another micro data factor 136 may be equal to 10× three-digit zip codes with at least ten patients per zip code.

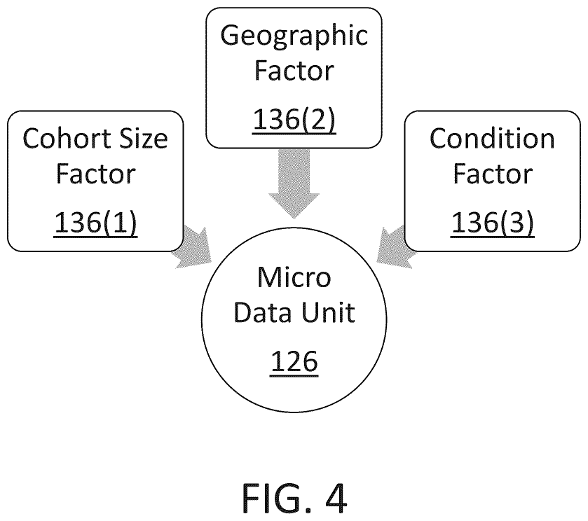

FIG. 4 shows one set of micro data factors 136 used to define a micro data unit 126. In FIG. 4 the set of micro data factors 136 used to define the micro data unit includes a cohort size factor 136(1), a geographic factor 136(2), and a condition factor 136(3). The set of micro data factors 136 used to define the micro data unit 126 may differ based on the field of research that the micro data unit 126 is being used in. For example, in the medical field, the plurality of data sets 116(1)-(n) may be healthcare data sets including information on a plurality of patients with each of the plurality of records corresponding to one of the plurality of patients. If the set of micro data factors 136 of FIG. 4 was used to measure the micro data units 126 in the plurality of data sets 116(1)-(n), the cohort size factor 136(1) may be measured in numbers of patients, the geographic factor 136(2) may be measured in numbers of regions, and the condition factor 136(3) may be a medical condition factor measured in numbers of medical conditions or numbers of ICD-10 codes.

To calculate the number of micro data units 126 in a particular data set 116, the micro data engine 110 may measure or determine the micro data quantity(ies) 168 of the data set 116 corresponding to the micro data factor(s) 136 being used to determine the number of micro data units 126 in the data set 116. The micro data quantity 168 is the discrete number of data entries 120 in a data field 122, combinations of data entries 120 in different data fields 122, or records that meet the criteria of a given micro data factor 136. As used herein, the micro data quantity 168 is measured by counting discrete data entries 120, combinations of data entries 120, or records 118 because data sets 116 or portions of data sets 116 that cover the same variable do not typically add additional research value. As an example, a first data set 116(1) may include data on one hundred subjects split evenly among five different zip codes, and a second data set 116(2) includes data on one hundred subjects split evenly among ten different zip codes. In this example, a researcher seeking data covering as many zip codes as possible with at least ten subjects in each zip code will likely prefer the second data set 116(2) over the first data set 116(1) as the second data set 116(2) includes ten discrete zip codes meeting the research criteria while the first data set 116(1) only has five discrete zip codes meeting the criteria even though the first data set 116(1) could be divided into ten sample populations (of ten subjects per zip code) if duplicate coverage of the same zip code were allowed.

As an example, if using a micro data factor 136 of 5× three-digit zip codes to determine the number of micro data units 126 in a given data set 116, the micro data engine 110 may determine the micro data quantity 168 of three-digit zip codes contained in the data set 116, which is the number of discrete three-digit zip codes covered by the data in the data set 116. As another example, if using a micro data factor 136 of 100× subjects within the fifty- to sixty-year-old age range having a minimum of ten measurements of a particular variable to determine the number of micro data units 126 in a given data set 116, the micro data engine 110 may determine the micro data quantity 168 of subjects within the fifty- to sixty-year-old age range in the data set 116, which is the number of subjects within the fifty- to sixty-year-old age range.

Once the micro data quantity 168 is determined, the micro data engine 110 may calculate a factor coverage value 138 by dividing the micro data quantity 168 by the corresponding micro data factor 136 to determine a factor coverage value 138. The factor coverage value 138 is a weighted measure of the scope of a given data set 116 with respect to the characteristics represented in the micro data factor 136. If only one micro data factor 136 is used to determine the number of micro data units 126 in a data set 116, the number of micro data units 126 in the data set 116 is equal to the factor coverage value 138. If two or more micro data factors 126 are being used to determine the number of micro data units 126 in a data set 116, the micro data engine 110 may calculate factor coverage values 138 by dividing each micro data quantity 168 by the corresponding micro data factor 136 to produce corresponding factor coverage values 138. In some embodiments, the number of micro data units 126 in the data set 116 is equal to the maximum of the calculated factor coverage values 138. Thus, the micro data engine 110 may assign a value of micro data units 126 to the data set 116 that is equal to the maximum calculated factor coverage value 138. The process of calculating the number of micro data units 126 in each data set may be repeated for each of the plurality of data sets 116(1)-(n) or the selection of the plurality of data sets 116(1)-(n).

Table 1 below provides examples of the calculation of the number of micro data units 126 in two data sets.

TABLE 1
Example Calculation of Micro Data Units in Data Sets A and B.

| | Data Set A | | | Data Set B | | |
|---|---|---|---|---|---|---|
| Characteristic | Sub- | Zip | Age | Sub- | Zip | Age |
| Measured | jects | Codes | Groups | jects | Codes | Groups |
| Micro Data Quantity | 500 | 20 | 6 | 300 | 30 | 4 |
| Micro Data Factor | 100 | 5 | 2 | 100 | 5 | 2 |
| Factor Coverage | 5 | 4 | 3 | 3 | 6 | 2 |
| Value | | | | | | |

| | | |
|---|---|---|
| Number of Data | 5 | 6 |
| Units in Data Set | | |

As shown in Table 1, Data Set A has micro data quantities 168 of five hundred subjects, twenty zip codes, and six age groups, and Data Set B has micro data quantities 168 of three hundred subjects, thirty zip codes, and four age groups. In other words, Data Set A contains data for five hundred subjects distributed among twenty different zip codes and six age groups while Data Set B contains data for three hundred subjects distributed over five different zip codes and four age groups. For Data Sets A and B, the micro data factors 136 include a cohort size factor 136(1) of one hundred subjects, a geographic factor 136(2) of five zip codes, and a demographic factor 136(4) of two age groups. By dividing the micro data quantities 168 by their respective micro data factors, Data Set A is calculated to have factor coverage values 138 of five for the number of subjects, four for the number of zip codes, and three for the number of age groups. As the maximum of the factor coverage values 138 for Data Set A is five, the number of micro data units 126 in Data Set A is five. Similarly, Data Set B is calculated to have factor coverage values 138 of three for the number of subjects, six for the number of zip codes, and two for the number of age groups. As the maximum of the factor coverage values 138 for Data Set B is six, the number of micro data units 126 in Data Set B is six.

Table 1 demonstrates how micro data units 126 can be used to quantify the value of data sets 116 containing different scopes of data in various dimensions. In this example, it can generally be inferred from the selected micro data factors 136 that data covering a greater number of zip codes has more research value than data covering a greater number of subjects as the micro data factor 136 for subjects is greater than the micro data factor 136 for zip codes. Accordingly, Data Set B contains more micro data units 126 than Data Set A despite Data Set B covering fewer subjects than Data Set A because Data Set B contains data for a substantially higher number of discrete zip codes. Further, it can generally be inferred from the micro data factors 136 of this example that data covering a greater number of age groups has more research value than data covering a greater number of zip codes in this context. However, Data Set B still contains more micro data units 126 than Data Set A despite Data Set A containing data covering more age groups because the number of additional age groups covered by Data Set A is too few to outweigh the value from the substantial number of additional age groups covered by the data in Data Set B.

In some embodiments, the number of micro data units 126 in the product data set is calculated directly as described above. In other embodiments, the number of micro data units in the product data set is determined indirectly by calculating the number of micro data units 126 in the plurality of data sets 116(1)-(n) and determining the number of micro data units 126 in the selection of the plurality of data sets 116(1)-(n) that are used to form the product data set 134. For example, the number of micro data units 126 in the product data set 134 may be determined by calculating the number of records 118 in each micro data unit 126 for each of the plurality of data sets. The number of records 118 from each of the plurality of data sets 116(1)-(n) used to form the product data set 134 may then be divided by the corresponding number of records 118 in each of the plurality of data sets 116(1)-(n) to determine how many micro data units 126 of data were taken from each data set 116.

The micro data engine 110 may be configured to transmit data to the client 130. For example, the micro data engine 110 may transmit the product data set 134 to the client 130 to the user device 112 via the data network 114. If multiple product data sets 134(1)-(n) are requested by the client 130, the micro data engine 110 may be configured to transmit multiple product data sets 134(1)-(n) to the client 130 to the user device 112 via the data network 114. The micro data engine 110 may transmit the product data set 134 in any suitable format or file type. Examples of suitable formats include but are not limited to CSV (Comma-Separated Values), JSON (JavaScript Object Notation), XML (Extensible Markup Language), XLSX (Excel Open XML Spreadsheet), ZIP (ZIP Archive), SQL (Structured Query Language), HDF5 (Hierarchical Data Format 5), Parquet, ORC (Optimized Row Columnar), and Avro. In some embodiments, the micro data engine 110 may transmit the product data set 134 in a format or file type included in the data request 128.

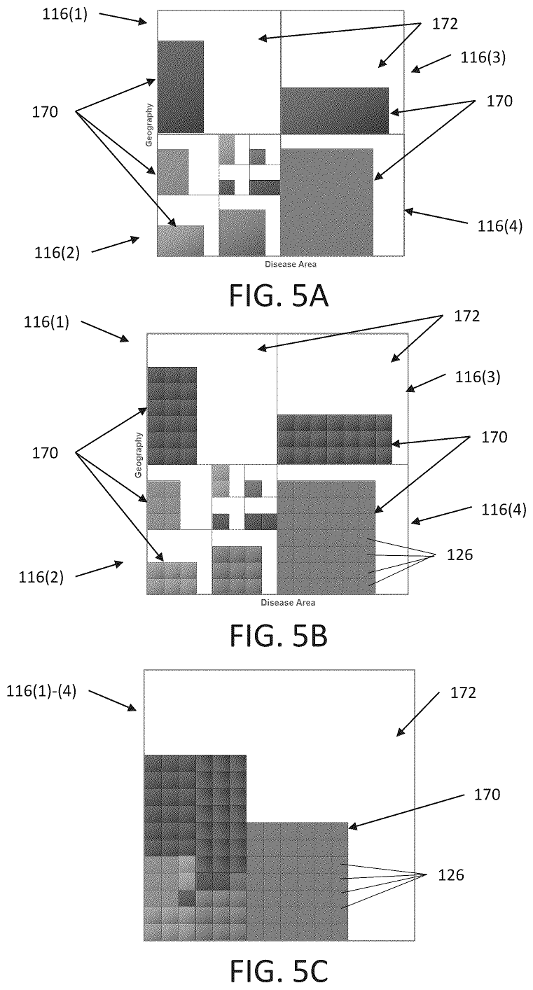

The micro data engine 110 may arrange the product data set 134 from the plurality data sets 116(1)-(n) in a way that reduces the amount of micro data units 126 that are transmitted to the client 130 and in turn increase the efficiency and performance of the system 100. FIGS. 5A-5C shows an example of four different data sets X(1)-(4) including data on different geographies and disease areas. In traditional data distribution systems, the entirety of data sets 116(1)-(4) would be transmitted to the client 130. However, as shown in FIG. 5A, only portions of the data sets 116(1)-(4) would be leveraged for research. In FIGS. 5A-5C, the leveraged data 170 are shown as darkened areas, and the unleveraged data 172 is represented by the white areas. As shown in FIG. 5B, the micro data engine 110 may calculate the number of micro data units 126 in the data sets 116(1)-(4) or in the leveraged data 170. As shown in FIG. 5C, the leveraged data 170 may be arranged into the product data set 134 which may be transmitted to the client 130. As demonstrated by FIG. 5C, the product data set 134 may be substantially smaller than the data sets X(1)-(4). Thus, transmission of the product data set 134 requires transmission of substantially less data than would be transmitted in traditional data distribution systems, resulting in a significant increase in the efficiency of the system 100.

The system 100 may include a data pricing module 174. In some embodiments, the data pricing module 174 may include software installed on or executed by the at least one processor 104. The data pricing module 174 may be a submodule of the micro data engine module 108, and the data pricing module 174 may cause the micro data engine 110 to perform one or more operations described herein. Although some operations may be described herein as being performed by the data pricing module 174, it is understood that such operations may also be imputed to the micro data engine 110, the micro data engine module 108, the at least one processor 104, the server 102, or the system 100. The data pricing module 174 may be configured to calculate the value of the data transmitted to the client. For example, the data pricing module 174 may calculate a price per micro data unit 140 for the micro data units 126 consumed by the client 130 or for the micro data units 126 in the product data set 134.

The data pricing module 174 may support or enforce rules for calculating the price per micro data unit 140. In some embodiments, the data pricing module 174 may include a predetermined maximum price 158 and a predetermined minimum price 160. The data pricing module 174 may be configured such that it cannot calculate a price above the predetermined maximum price 158 or below the predetermined minimum price 160.

In some embodiments, the data pricing module 174 may determine that the calculated price per micro data unit 140 is above a predetermined lower price 150 or below a predetermined upper price 152. The predetermined lower price 150 and predetermined upper price 152 act as thresholds, the crossing of which causes further action to occur, but the data pricing module 174 may still calculate prices below the predetermined lower price 150 or above the predetermined upper price 152. For example, the data pricing module 174 may calculate a price per micro data unit 140 that it determines to be below the predetermined lower price 150 or above the predetermined upper price 152, and the data pricing module may then transmit a notification 154 to an analyst 156 to review the calculated price per micro data unit 140 if the data pricing module 174 determines that the calculated price per micro data unit 140 is below the predetermined lower price 150 or above the predetermined upper price 152. The notification 154 may be transmitted to the analyst 156 via the user device 112.

The data pricing module 174 may store the calculated price per micro data unit 140 in the at least one memory 106. The data pricing module 174 may store the calculated price per micro data unit 140 in the at least one memory 106 with an attestable time stamp 175. As the data pricing module 174 calculates different prices per micro data unit 140 over time, each calculated price per micro data unit 140 may be stored with a time stamp 175. The time stamp 175 may be from a third-party service or may be produced using a ledger-style store. When the time stamp 175 from a third-party service is used, the data pricing module 174 may request and receive an attestable time stamp 175 from the third-party service via the data network 114. The time stamp 175 may be used to show the provenance of the calculated price per micro data unit 140 during an audit.

The data pricing module 174 may be configured to calculate the value of the data transmitted to the client 130 by analyzing external metadata 142 and/or internal metadata 144. As used herein, external metadata 142 is descriptive information or data that is collected from outside of the system or from third parties. External metadata 142 generally relates to data sets that are owned, sold, licensed, or otherwise offered for sale by third parties or other information that may influence the market price of data. Examples of external metadata 142 include market supply metadata 142(1) on the market supply of the requested data; market demand metadata 142(2) on the market demand for the requested data; availability metadata 142(3) on the availability and/or total population of the requested data; market size metadata 142(4) on the market size for a potential solution; or data price metadata 142(5) on data prices of alternative data sources.

In some embodiments, the system 100 may include an external metadata collection module 176 for gathering external metadata 142. In some embodiments, the external metadata collection module 176 may include software installed on or executed by the at least one processor 104. The external metadata collection module 176 may be a submodule of the micro data engine module 108, and the external metadata collection module 176 may cause the micro data engine 110 to perform one or more operations described herein. Although some operations may be described herein as being performed by the external metadata collection module 176, it is understood that such operations may also be imputed to the micro data engine 110, the micro data engine module 108, the at least one processor 104, the server 102, or the system 100.

The external metadata collection module 176 may be configured to collect external metadata 142 via the data network 114. Particularly, the external metadata collection module 176 may access third-party data sources such as data markets 113 via the data network 114 to collect external metadata 142. For example, the external metadata collection module 176 may extract data from product descriptions, prices, reviews, news articles, and marketing materials from competitor websites, data exchanges, blogs, and other sources. The external metadata collection module 176 may aggregate such external metadata 142 and provide the external metadata 142 to the data pricing module 174 for analysis. The external metadata collection module 176 may collect external metadata 142 periodically or constantly. In some embodiments, the external metadata collection module 176 may collect external metadata 142 automatically or in response to a request from a user device 112 via the data network 114.

As used herein, internal metadata 144 is descriptive information or data that is collected from within the system 100. Internal metadata 144 generally relates to information or data about the plurality of data sets 116(1)-(n), which may provide insight into the market price of data. Internal metadata 144 includes volume data 146 or quality data 148. Volume data 146 may include information about the amount of a particular type of data within the plurality of data sets 116(1)-(n). If a large volume of a particular type of data is contained in the plurality of data sets 116(1)-(n), a lower price for the data may be justified. In contrast, if a small volume of a particular type of data is contained in the plurality of data sets 116(1)-(n), a higher price may be justified.

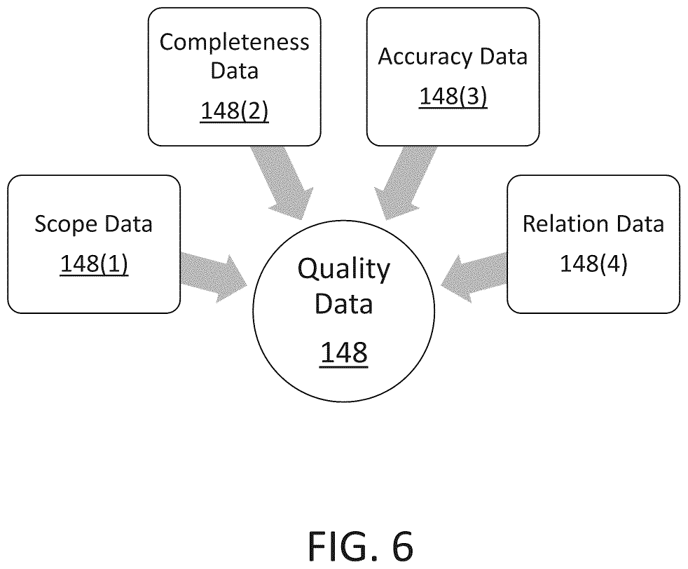

Quality data 148 may include data about the condition of the plurality of data sets 116(1)-(n) or a subset of the plurality of data sets 116(1)-(n). High-quality data may justify a higher price, and low-quality data may justify a lower price. FIG. 6 illustrates the subcategories of data that may comprise the quality data 148. Quality data 148 about a data set 116 may include at least one of the scope data 148(1), completeness data 148(2), accuracy data 148(3), or relation data 148(4) (e.g., data in different data fields in the plurality of records). As used herein, scope data 148(1) may refer to data about the total breadth of data fields 122 contained in a data set 116 or the presence of specific data fields 122 needed for a particular use case. Completeness data 148(2) may refer to data about how well one or more data fields 122 are populated. Accuracy data 148(3) may refer to data about how correct the data entries 120 in the data fields 122 are or, when data fields 122 include industry-standard codes (e.g., ICD 10 codes for disease classification, NDC codes for drug classification, CPT codes for medical procedure classification, or DRG codes for medical diagnoses), how correctly such codes are applied to the data set 116. Relation data 148(4) may refer to data about the relatedness of the different data fields or data entries.

In some embodiments, the system 100 may include an internal metadata collection module 178 for gathering internal metadata 144. In some embodiments, the internal metadata collection module 178 may include software installed on or executed by the at least one processor 104. The internal metadata collection module 178 may be a submodule of the micro data engine module 108, and the internal metadata collection module 178 may cause the micro data engine 110 to perform one or more operations described herein. Although some operations may be described herein as being performed by the internal metadata collection module 178, it is understood that such operations may also be imputed to the micro data engine 110, the micro data engine module 108, the at least one processor 104, the server 102, or the system 100.

In some embodiments, the internal metadata collection module 178 may be configured to collect internal metadata 144 about the plurality of data sets 116(1)-(n) or subsets thereof. The internal metadata collection module 178 may include a plurality of data templates 124 corresponding to the plurality of data fields 122. Data templates 124 allow the internal metadata collection module 178 to analyze attributes of the data sets 116(1)-(n) and their meta-attributes, including uniqueness across data sets 116(1)-(n), ability to be blank, and type (e.g., numeric, limited selection, dichotomous, and free text). In some embodiments, the internal metadata collection module 178 may be configured to collect internal metadata 144 by comparing the plurality of data templates 124 to the corresponding plurality of data fields 122 in the records 118 of the plurality of data sets 116.

In some embodiments, the calculated price per micro data unit 140 may be based on a tiered pricing system including a standard tier and a premium tier. In such embodiments, the data pricing module 174 may calculate a price per standard micro data unit 140(1) and a price per premium micro data unit 140(2). The micro data unit 126 being provided under either tier may be the same micro data unit 126. However, purchasing micro data units 126 under the premium tier may provide the client with additional rights to the micro data units 126. For example, the standard tier may only allow the client 130 to purchase data. In contrast, the premium tier may allow the client 130 to purchase the data, return the data, utilize the data with professional services, and utilize price optimization across the data set.

When multiple product data sets 134(1)-(n) are transmitted to the client 130, the micro data engine 110 may be configured to detect overlap in the data contained in the multiple product data sets 134(1)-(n). For example, when the first and second product data sets 134(1)-(2) are transmitted to the client 130, the micro data engine 110 may detect overlapping data between the first product data set 134(1) and the second product data set 134(2). The micro data engine 110 may be configured to collect an overlap in the data contained in multiple product data sets 134(1)-(n) even when the multiple product data sets 134(1)-(n) are provided in response to separate data requests 128(1)-(n). For example, the micro data engine 110 may receive a first data request 128(1) from the client 130 for the first product data set 134(1) to be used in a first study and may receive a second data request 128(2) from the client 130 for the second product data set 134(1) to be used in a second, unrelated study. The micro data engine 110 may detect overlapping data between the first product data set 134(1) and the second product data set 134(2). Based on the detection of overlapping data between multiple product data sets 134(1)-(n), the micro data engine 110 may calculate the number of discrete micro data units 126 in the first and second product data sets 134(1)-(2). The number of discrete micro data units 126 excludes duplicate micro data units 126 in the first and second product data sets 134(1)-(2).

The micro data engine 110 may transmit an invoice 162 recording the transaction to the client 130. In some embodiments, the micro data engine 110 may transmit the invoice 162 to the user device 112 of the client 130 via the data network 114. The invoice 162 may include a price or pricing data 180 based on the calculated price per micro data unit 140 and a number of micro data units 126. In some embodiments, the number of micro data units 126 is the number of micro data units 126 in the product data set 134. In other embodiments, the number of micro data units 126 is the number of discrete micro data units 126 in multiple product data sets 134(1)-(n). In still other embodiments, the number of micro data units 126 is the number of micro data units 126 consumed by the client 130 (i.e., delivered to the client 130 via the data network 114).

The transaction with the client 130 may have several different structures. In some embodiments, the transaction takes on a “pay as you go” structure in which the micro data engine 110 transmits the invoice 162 to the client 130 on a predefined cadence (e.g., bimonthly, monthly, quarterly, semiannually, etc.). In such embodiments, the invoice 162 may include a payment request 182. The micro data engine 110 may be configured to receive a payment 164 from the client 130 in response to the invoice 162 or the payment request 182 in the invoice. The micro data engine 110 may receive the payment 164 request through wire transfer, credit/debit card, cryptocurrency, or other common forms of electronic payment.

In other embodiments, the client 130 may purchase a prepaid allowance of micro data units 126 to use in a predetermined period. In such embodiments, the invoice 162 may not include a payment request 182 but would show a deduction of micro data units 126 from the allowance and the number of micro data units 126 remaining on the allowance. In still other embodiments, the client may pay a flat rate per period (e.g., bimonthly, monthly, quarterly, semiannually, etc.) and be able to request unlimited or substantially unlimited data. Such embodiments may include a relatively high maximum limit of micro data units 126 such that use is not actually unlimited but is substantially unlimited. In such embodiments, the invoice 162 may simply provide information on the client's data usage.

The micro data engine 110 may be configured to receive from the client unused data 165. For example, the client may transmit unused data 165 from the product data set(s) 134(1)-(n) back to the micro data engine. The micro data engine 110 may verify that the data is unused data using digital watermarks, encryption, or other security measures to verify that the status of the data. The micro data engine 110 may issue a refund of any payment 164 that was received for the unused data 165. For example, the micro data engine 110 may issue a pro-rata refund of the payment 164 received for the product data set 134 based on the proportion of the product data set 134 that is unused.

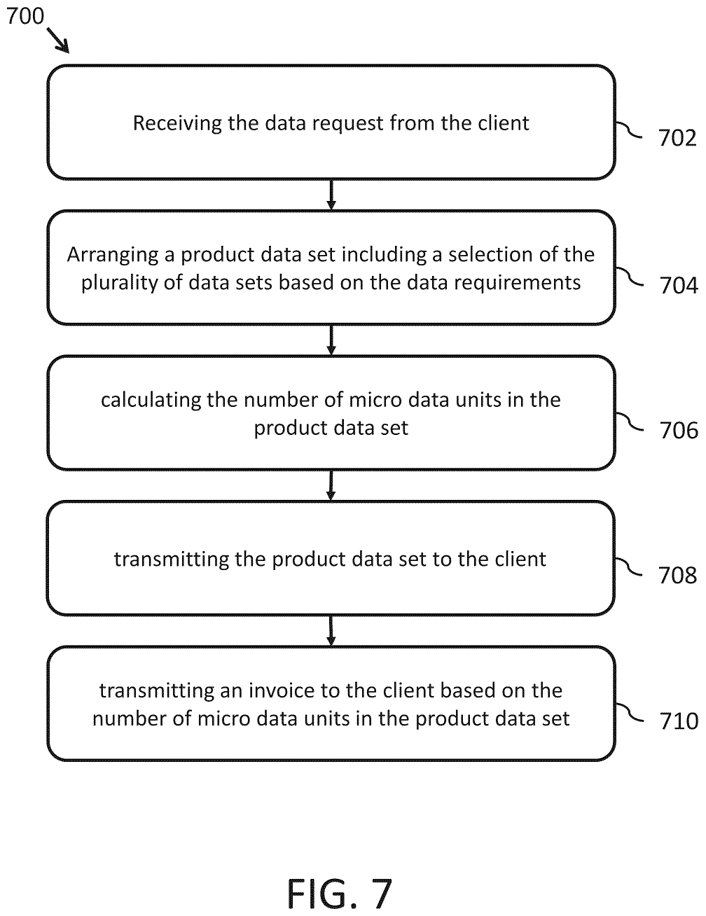

FIGS. 7-9 depicts various embodiments of methods of the present disclosure. The methods may be computer-implemented methods. The methods may include one or more steps. Some embodiments of the method may include providing a system 100. The system 100 may include the system of FIG. 1. The system 100 may include the server 102 with at least one processor 104 and at least one memory 106. In some embodiments, the methods may include storing one or more non-transitory computer-executable instructions 125 and a plurality of data sets 116(1)-(n). The method may include executing the non-transitory computer-executable instructions 125 on the at least one processor 104.

In the embodiment shown in FIG. 7, the method 700 may include receiving 702 the data request 128 from the client 130. The data request 128 may include data requirements 132. The method 700 may include arranging 704 a product data set 134 including a selection of the plurality of data sets 116(1)-(n) based on the data requirements 132. The method 700 may include calculating 706 the number of micro data units 126 in the product data set 134. The method 700 may include transmitting 708 the product data set 134 to the client 130. The method 700 may include transmitting 710 an invoice 162 to the client 130 based on the number of micro data units 126 in the product data set 134.

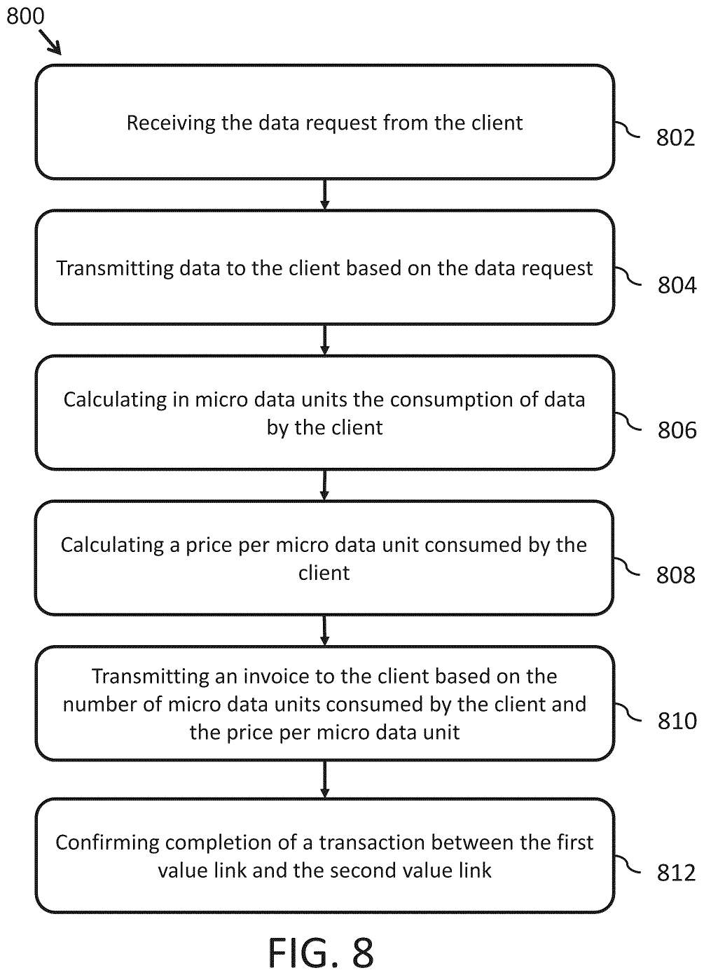

In the embodiment shown in FIG. 8, the method 800 may include receiving 802 a data request 128 from a client 130. The method 800 may include transmitting 804 data to the client 130 based on the data request 128. The method 800 may include calculating 806 in micro data units 126 the consumption of data by the client 130. The method 800 may include calculating 808 a price per micro data unit 140 consumed by the client 130. The method 800 may include transmitting 810 an invoice 162 to the client 130 based on the number of micro data units 126 consumed by the client 130 and the price per micro data unit 140.

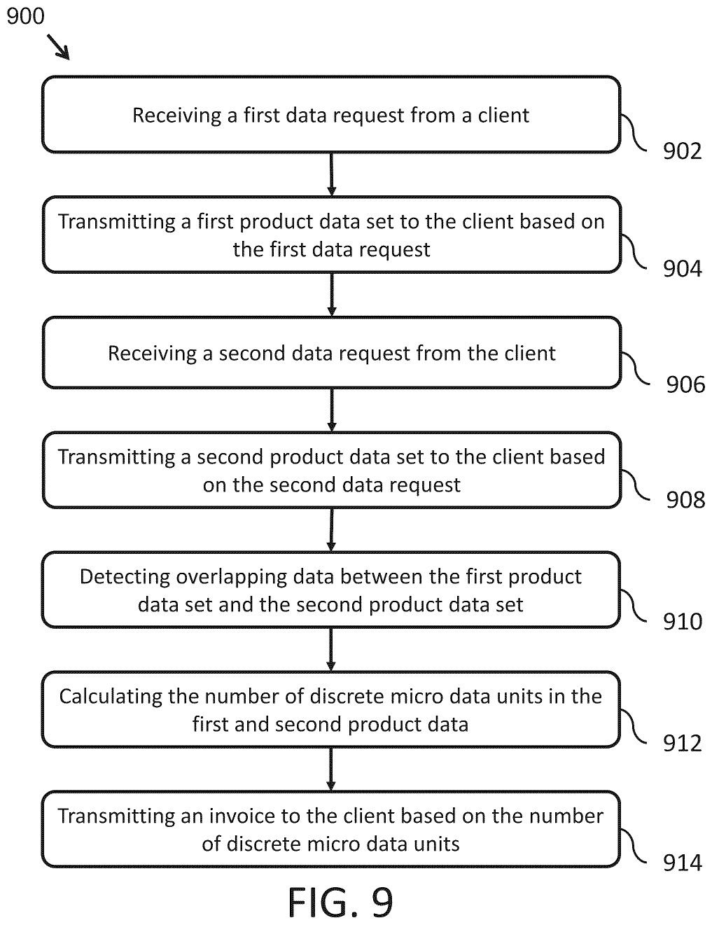

In the embodiment shown in FIG. 9, the method 900 may include receiving 902 a first data request 128(1) from a client 130. The method 900 may include transmitting 904 a first product data set 134(1) to the client 130 based on the first data request 128(1). The method 900 may include receiving 906 a second data request 128(2) from the client 130. The method 900 may include transmitting 908 a second product data set 134(2) to the client 130 based on the second data request 128(2). The method 900 may include detecting 910 overlapping data between the first product data set 134(1) and the second product data set 134(2). The method 900 may include calculating 912 the number of discrete micro data units 126 in the first and second product data 134(1)-(2). The number of discrete micro data units 126 may exclude any duplicate micro data units 126 in the first and second product data sets 134(1)-(2). The method 900 may include transmitting 914 an invoice 162 to the client 130 based on the number of discrete micro data units 126.

The methods of the present disclosure, including the methods shown in FIGS. 7-9, may include one or more other steps or operations which the micro data engine module or its submodules are configured to perform.

As will be appreciated by one skilled in the art, aspects of the present disclosure may be embodied as an apparatus, system, method, computer program product, or the like. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer readable medium(s) having program code embodied thereon.

In some embodiments, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more non-transitory, computer-readable medium(s). Furthermore, although some module functionality is disclosed herein, some functionality associated with one module may be performed by a different module in some embodiments.

The computer program product may include a computer readable storage medium (or media) having computer-readable (i.e., computer executable) program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processor devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processor device receives computer readable program instructions from the network and forwards the computer readable program instructions for storage in a computer readable storage medium within the respective computing/processor device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the C programming language or similar programming languages. The computer readable program instructions may execute on a supercomputer, a compute cluster, or the like. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations or block diagrams of methods, apparatuses, systems, or computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flow chart diagrams included herein are generally set forth as logical flow chart diagrams. As such, the depicted order and labeled steps are indicative of one embodiment of the presented method. Other steps and methods may be conceived that may be equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Thus, although there have been described particular embodiments of the present invention of new and useful SYSTEMS AND METHOD FOR UTILITY CONSUMPTION OF DATA, it is not intended that such references be construed as limitations upon the scope of this invention.

What is claimed is:

1. A system for utility consumption of data, comprising:
at least one processor; and
at least one memory storing one or more non-transitory computer-executable instructions and a plurality of data sets,
wherein the at least one processor, in response to executing the one or more instructions, implements a method including
receiving a data request from a client, the data request including data requirements,
arranging a product data set including a selection of the plurality of data sets based on the data requirements,
calculating the number of micro data units in the product data set,
transmitting the product data set to the client, and
transmitting an invoice to the client based on the number of micro data units in the product data set.

2. The system of claim 1, wherein the step of calculating the number of the micro data units in the product data set is performed using one or more micro data factors.

3. The system of claim 2, wherein each of the plurality of data sets comprises a plurality of records each including data entries in one or more data fields corresponding to the one or more micro data factors, and wherein the calculating the number of the micro data units in the product data set includes dividing the number of discrete data entries in the one or more data fields in the plurality of data sets by the corresponding one or more micro data factors to determine one or more factor coverage values, assigning the maximum of the one or more factor coverage values for the each of the plurality of data sets as the number of micro data units in each of the plurality of data sets, and determining the number of micro data units in the selection of the plurality of data sets forming the product data set.

4. The system of claim 3, wherein the calculating the number of micro data units in the product data set comprises calculating the number of records in each micro data unit for each of the plurality of data sets, and dividing the number of records in the product data from each of the plurality of data sets by the number of records in each micro data unit for each of the plurality of data sets.

5. The system of claim 2, wherein the micro data factors include at least one of:
a size of cohort factor measured in number of subjects;
a geographic factor measured in the number of regions; or
a condition factor measured in number of discrete variables for research contained in the data.

6. The system of claim 2, wherein the plurality of data sets are healthcare data sets including health information on a plurality of patients with each of the plurality of records corresponding to one of the plurality of patients, wherein the micro data factors include at least one of:
a cohort size factor measured in number of patients;
a geographic factor measured in number of regions; or
a medical condition factor measure in number of ICD-10 codes.

7. The system of claim 1, wherein the data requirements include at least one of:
geographic requirements;
demographic requirements; or
condition requirements.

8. The system of claim 7, wherein the arranging of the product data set includes analyzing the data requirements for data need coverage.

9. The system of claim 8, wherein the analyzing of the data requirements includes performing data point counts and analyzing the at least one of:
the geographic requirements;
the demographic requirements; or
the condition requirements.

10. The system of claim 1, wherein the method implemented by the at least one processor further comprises:
receiving a payment from the client in response to the invoice;
receiving from the client unused data from the product data set; and
issuing a refund of the payment based on the amount of unused data from the product data set.

11. A system for utility consumption of data, comprising:
at least one processor; and
at least one memory storing one or more instructions and a plurality of data sets,
wherein the at least one processor, in response to executing the one or more instructions, implements a method including
receiving a data request from a client,
transmitting data to the client based on the data request,
calculating in micro data units the consumption of data by the client,
calculating a price per micro data unit consumed by the client, and
transmitting an invoice to the client based on the number of micro data units consumed by the client and the price per micro data unit.

12. The system of claim 11, wherein the calculating the price per micro data unit includes analyzing external metadata, analyzing internal metadata, or analyzing both external metadata and internal metadata.

13. The system of claim 12, wherein the external metadata includes at least one of:
market supply metadata;
market demand metadata;
availability metadata;
market size metadata; or
data price metadata.

14. The system of claim 13, wherein the method implemented by the at least one processor comprises collecting external metadata automatically and constantly.

15. The system of claim 12, wherein the internal metadata comprises at least one of quality data and volume data about the plurality of data sets.

16. The system of claim 15, wherein the plurality of data sets each comprise a plurality of records including a plurality of data fields, and wherein the quality data includes at least one of:
scope data;
completeness data;
accuracy data; or
relation data.

17. The system of claim 16, wherein the at least one memory stores a plurality of data templates corresponding to the plurality of data fields, and wherein the method implemented by the at least one processor comprises collecting internal metadata by comparing the plurality of data templates to the corresponding plurality of data fields.

18. The system of claim 11, wherein the method implemented by the at least one processor further comprises:
determining that the calculated price per micro data unit is below a predetermined lower price; and
transmitting a notification to an analyst to review the calculated price per micro data unit.

19. The system of claim 11, wherein the method implemented by the at least one processor further comprises:
determining that the calculated price per micro data unit is above a predetermined upper price; and
transmitting a notification to an analyst to review the calculated price per micro data unit.

20. The system of claim 11, wherein the at least one memory stores a predetermined maximum price and a predetermined minimum price, and wherein the calculated price per micro data unit is between the predetermined minimum price and the predetermined maximum price.

21. The system of claim 11, wherein the calculating in micro data units the consumption of data by the client is performed over a time interval based on the data requirements.

22. A system for utility consumption of data, comprising:
at least one processor; and
at least one memory storing one or more instructions and a plurality of data sets,
wherein the at least one processor, in response to executing the one or more instructions, implements a method including
receiving a first data request from a client,
transmitting a first product data set to the client based on the first data request,
receiving a second data request from the client,
transmitting a second product data set to the client based on the second data request,
detecting overlapping data between the first product data set and the second product data set,
calculating the number of discrete micro data units in the first and second product data, wherein the number of discrete micro data units excludes any duplicate micro data units in the first and second product data sets, and
transmitting an invoice to the client based on the number of discrete micro data units.
